(19) United States
(12) Patent Application Publication
(10) Pub. No.: US 2009/0320246 A1
(43) Pub. Date: Dec. 31, 2009

(54) HINGE AND ELECTRICAL DEVICE WITH SAME

(75) Inventor: SONG-LING YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/396,478

(22) Filed: Mar. 3, 2009

(30) Foreign Application Priority Data
Jun. 27, 2008 (CN) 200810302401.7

(51) Int. Cl. E05D 5/12

(52) U.S. Cl. 16/380

(57) ABSTRACT

A hinge includes an axle half hinge and a bracket half hinge rotatably connecting to the axle half hinge. The axle half hinge includes a first arm portion and a pivot shaft portion formed on an end of the first arm portion. The first arm portion defines a first cavity therein for receiving a cable(s), the pivot shaft portion defines a pivot hole communicating with the first cavity of the first arm portion. The bracket half hinge includes a second arm portion and a bracket portion formed on an end of the second arm portion. The second arm portion defines a second cavity therein for receiving the cable(s), and the bracket portion defines a receiving space for receiving the pivot shaft portion of the axle half hinge therein.

### TECHNICAL FIELD

The present disclosure generally relates to a hinge and an electrical device with the hinge.

### BACKGROUND

With rapid developments in the electronic industry, hinges are widely used in electrical devices to rotatably connect two different sections of the electrical device. To electrically connect the two different sections of the electrical device, cables are mounted through hinge joining the two different sections. As hinge becomes smaller the cables can only be mounted on the side of the hinge. However, having the cables on the side of a hinge submits the cables to fraying or even breakage under the rotation of the hinge, thus, the lifetime of the electrical device may be reduced.

What is needed, therefore, is a hinge to overcome the above mentioned problems.

### BRIEF DESCRIPTION OF THE DRAWINGS

FIG. 1 is an isometric view of a hinge according to an exemplary embodiment of the invention.

FIG. 2 is similar to FIG. 1, but showing the hinge from a different angle.

FIG. 3 is an exploded view of the hinge of FIG. 1.

FIG. 4 is similar to FIG. 2, but showing the hinge from a different angle.

FIG. 5 is an isometric view of an electrical device with the hinge of FIG. 1.

FIG. 6 is an exploded view of the electrical device of FIG. 1.

FIG. 7 is a semi-assembled view of the electrical device of FIG. 6

FIG. 8 is a partially enlarged view of FIG. 7.

### DETAILED DESCRIPTION OF THE EMBODIMENTS

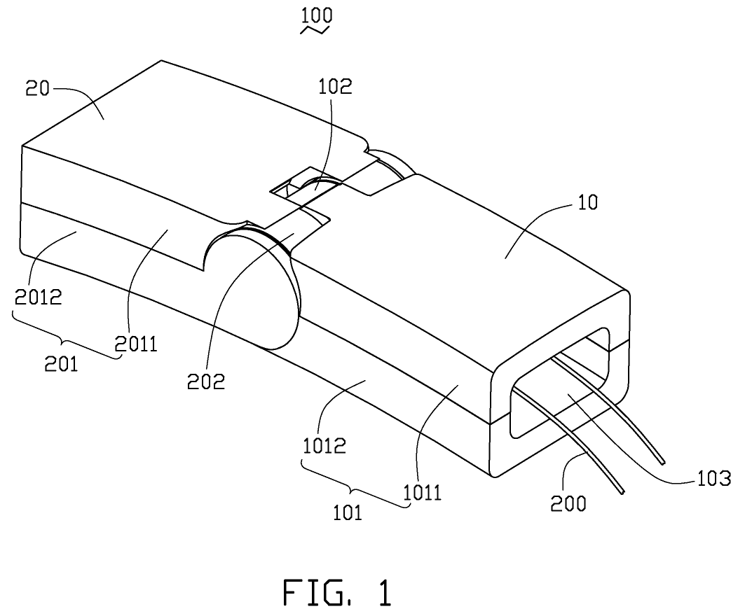

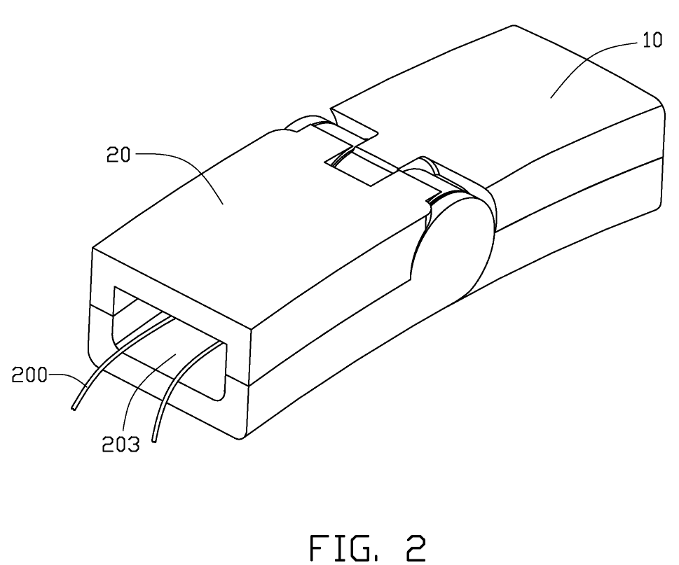

Referring to FIGS. 1 and 2, a hinge 100, according to an exemplary embodiment, is shown. The hinge 100 includes an axle half hinge 10 and a bracket half hinge 20 rotatably connecting to the axle half hinge 10.

The axle half hinge 10 includes a first arm portion 101 and a pivot shaft portion 102 formed on one end of the first arm portion 101. The first arm portion 101 defines a first cavity 103 therein for receiving a cable(s) 200. The first arm portion 101 further includes a first upper portion 1011 and a first lower portion 1012 coupled with the first upper portion 1011. The first upper portion 1011 and the first lower portion 1012 each has a u-shaped section. When coupled together, the first upper portion 1011 and the first lower portion 1012 form the first cavity 103.

The bracket half hinge 20 includes a second arm portion 201 and a bracket portion 202 formed on an end of the second arm portion 201. The second arm portion 201 defines a second cavity 203 for receiving the cable(s) 200. The second arm portion 201 further includes a second upper portion 2011 and a second lower portion 2012 coupling with the second upper portion 2011. The second upper portion 2011 and the second lower portion 2012 each has a u-shaped section. When coupled together, the second upper portion 2011 and the second lower portion 2012 form the second cavity 203.

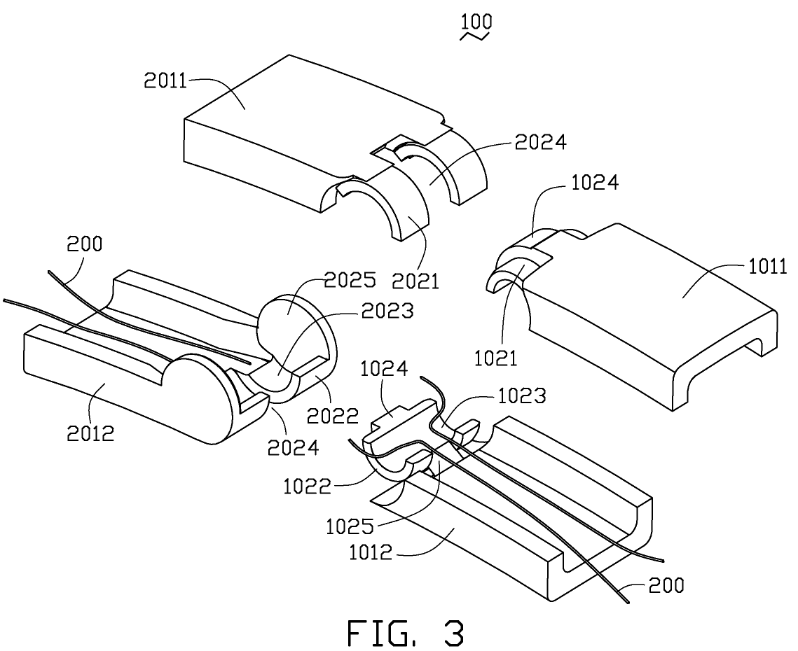

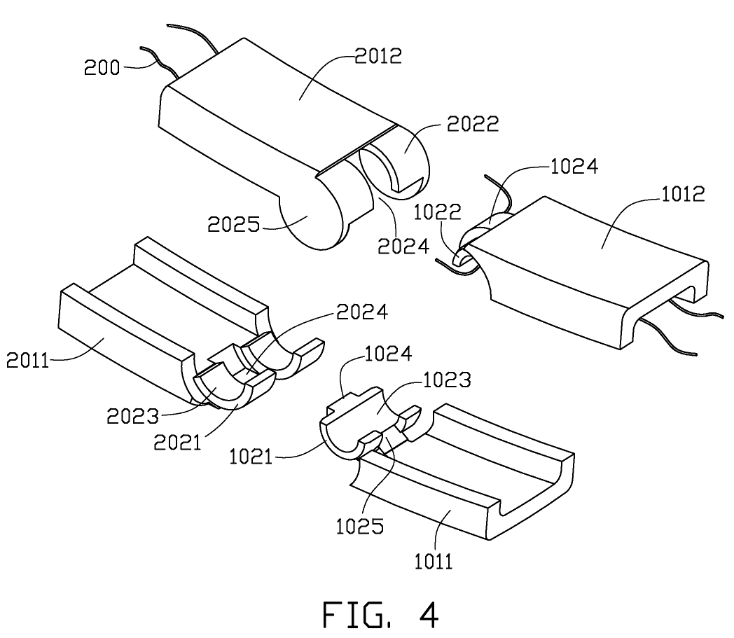

Referring to FIGS. 3 and 4, the pivot shaft portion 102 includes an upper half shaft 1021 and a lower half shaft 1022. The upper half shaft 1021 is formed on an end of the first upper portion 1011, and the lower half shaft 1022 formed on an end of the first lower portion 1012 corresponding to the upper half shaft 1021. The upper half shaft 1021 and the lower half shaft 1022 are arc-shaped, when coupled together, the upper half shaft 1021 and the lower half shaft 1022 define a pivot hole 1023 therebetween.

The bracket portion 202 includes an upper bracket 2021 and a lower bracket 2022, the upper bracket 2021 formed on an end of the second upper portion 2011 and the lower bracket 2022 formed on an end of the second lower portion 2012 corresponding to the upper bracket 2021, and when coupled together, the upper bracket 2021 and the lower bracket 2022 define a receiving space 2023 for receiving the pivot shaft portion 102 therein.

The pivot shaft portion 102 further includes a flange 1024 partly formed on the outer surface of the upper half shaft 1021 and partly formed on the outer surface the lower half shaft 1022. The flange 1024 is connected to the first arm portion 101. The upper half shaft 1021 and the lower half shaft 1022 each defines a gap 1025 near the first upper portion 1011 and the first lower portion 1012 correspondingly.

The bracket portion 202 defines a space 2024, the space 2024 is partly defined in the upper portion 2021 and partly defined in the lower yoke 2022. The bracket portion 202 further includes two side covers 2025 formed on two opposite sides of the lower portion 2022 for covering the two sides of the bracket portion 202.

The first upper portion 1011 and the first lower portion 1012 can be coupled together by adhesive or hotpress. And, the second upper portion 2011 and the second lower portion 2012 can also be coupled together by adhesive or hotpress.

When assembling the hinge 100, firstly, insert the lower half shaft 1022 of the axle half hinge 10 into the receiving space 2023 of the lower bracket 2022 of the bracket half hinge 20. Secondly, couple the first upper portion 1011 and the first lower portion 1012 of the axle half hinge 10 together, then the upper half shaft 1021 and the lower half shaft 1022 are also coupled together. Finally, couple the second upper portion 2011 and the second lower portion 2012 of the bracket half hinge 20 together. The flange 1024 of the pivot shaft portion 102 of the axle half hinge 10 is engaged into the space 2024 of the bracket portion 2022 of the bracket half hinge.

During the hinge 100 assembling, a cable(s) 200 can be set in the hinge 100. The cable(s) 200 first passes through the second cavity 203 and the pivot shaft portion 102, then passes out of the pivot shaft portion 102 from the gap 1025, finally the cables passes through the first cavity 103 of the axle half hinge 10. Thus the cable will be loosely fitted and not be subjected to abrasions or frazzling or being broken, and therefore, the electronic device that uses the hinge 100 has a longer usage life.

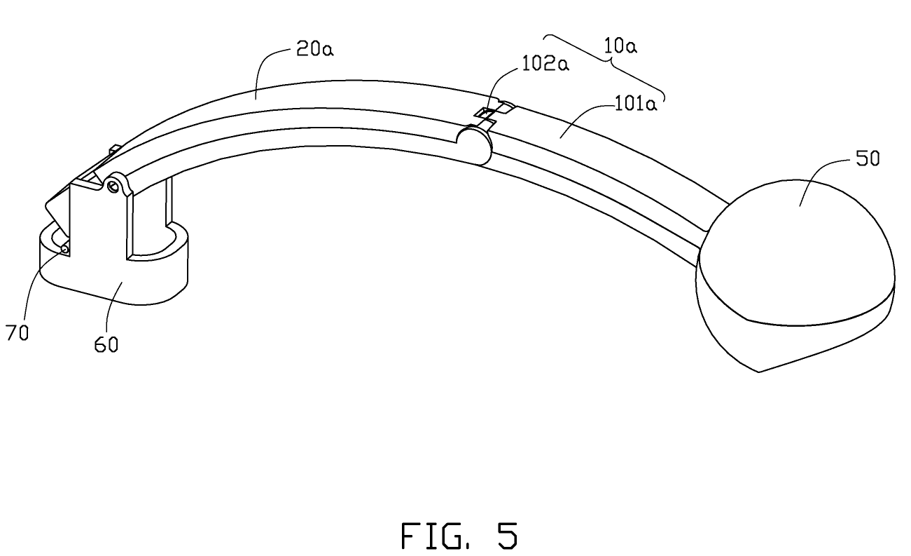

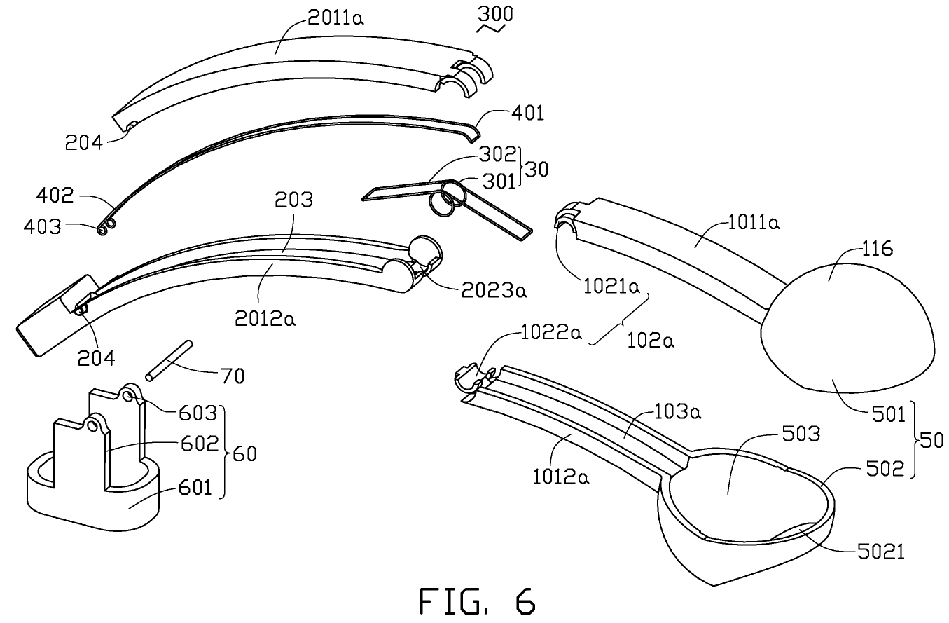

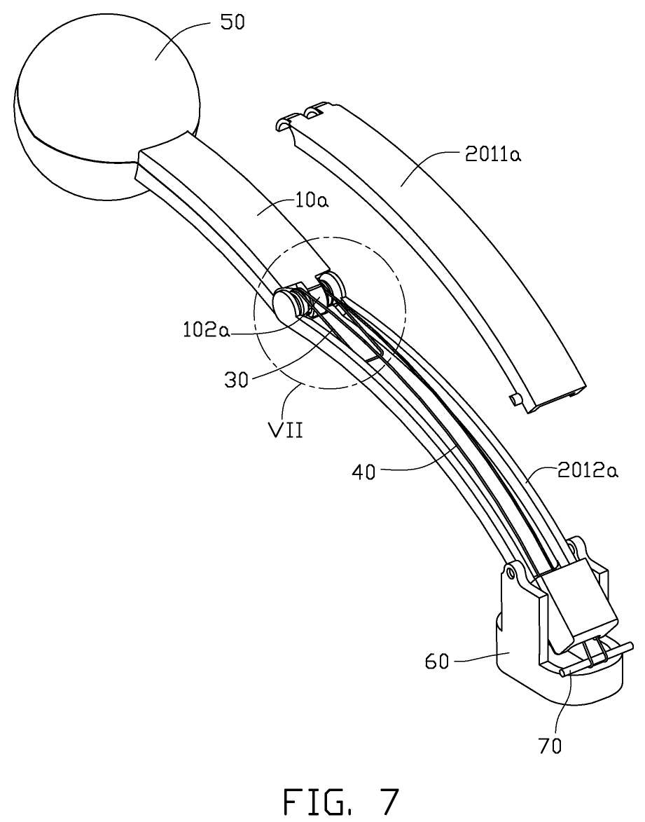

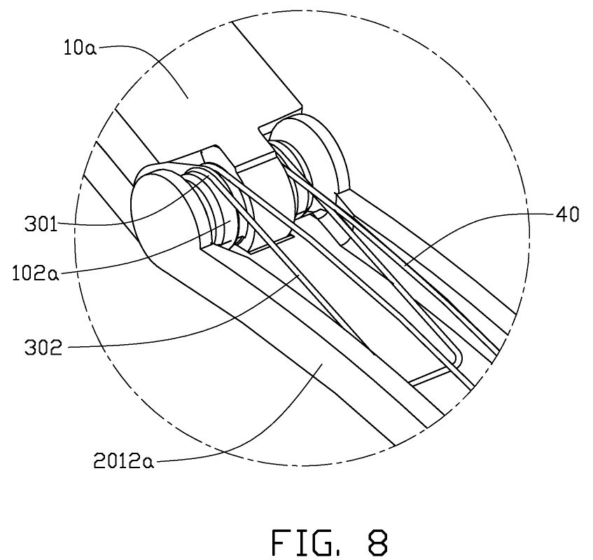

The hinge 100 can be used in any electrical device which has two different sections rotatably and electrically connected to each other. Referring to FIGS. 5-8, an electrical device 300 with the hinge is shown, the axle half hinge 10a and the bracket half hinge 20a are correspondingly extended in two opposite directions. The electrical device 300 further includes an elastic member 30 mounted between the joint of the axle half hinge 10a and the bracket half hinge 20a, a dragging member 40 passing through a second cavity 203a of the bracket half hinge 20a, a combining cap 50 formed on the end of the axle half hinge 10a, and a pedestal 60 connected to the end of the bracket half hinge 20a. One end of the dragging member 40 is connected to the axle half hinge 10a, and the other end of the dragging member 40 extends out of an end of the bracket half hinge 20a away from the axle half hinge 10a.

The elastic member 30 includes a helix portion 301 and a pair of elastic feet 302 extending from two opposite ends of the helix portion 301. The helix portion 30 is mounted around the pivot shaft portion 102a of the axle half hinge 10a, the pair of elastic feet 302 are correspondingly resisted on the axle half hinge 10a and the bracket half hinge 20a.

The dragging member 40 includes a fixed end 401 and a dragging end 402 opposite to the fixed end 401. The fixed end 401 is fixed on a side of the pivot shaft portion 102a near the arm portion 101a of the axle half hinge 10a, while the dragging end 402 defines two first through holes 403.

A pull rod 70 is passed through the first through holes 403. The pull rod 70 can be pulled by a mechanism (not shown), such as a stepping motor, to drive the axle half hinge 10a rotating relative to the bracket half hinge 20a.

The combining cap 50 is used for receiving an electrical element (not shown) therein. The combining cap 50 includes a first half cap 501 formed on the end of the first upper portion 1011a and a second half cap 502 formed on the end of the first lower portion 1012a, when coupled together, the first half cap 501 and the second half cap 502 form a third cavity 503 for receiving an electrical element therein. The third cavity 502 communicates with the first cavity 102a. The second half cap 502 defines an opening 5021 for unfolding an output/input interface of the electrical element.

The electrical element may be a camera module or a microphone, and so on.

The pedestal 60 includes an annular seat 601 and two opposite supporting plates 602 integrated with the annular seat 601. The supporting plates 602 each defines a second through hole 603. Two engaging feet 204 are formed on opposite sides of the bracket half hinge 20a correspondingly. The engaging feet 204 are engaged in the second through holes 603 correspondingly. Alternatively, the engaging feet 204 can be formed on the end of the second upper portion 2011a or the end of the second lower portion 2012a of the bracket half hinge 20a, in this embodiment, the engaging feet 204 are partly formed on the end of the second upper portion 2011a and partly formed on the second lower portion 2012a of the bracket half hinge 20a.

When assembling the electrical device 300 with the hinge, firstly, fix the fixed end 401 of the dragging member 40 on the side surface of the upper half shaft 1021a near the first arm portion 101a, and fix the elastic member 30 on the shaft portion 102a by surrounding the helix portion 301 of the elastic member 30 on the upper half shaft 1022a of the axle half hinge 10a. Secondly, couple the first upper portion 1011a and the first lower portion 1012a of the axle half hinge 10a together with an elastic foot 302 of the elastic member 30 inserted into the first hollow 103a. Then, put the pivot shaft portion 102a of the axle half hinge 10a into the receiving space 2023a of the bracket half hinge 20a with the dragging end 402 passing out of the second cavity 203a of the second lower portion 2012a. Finally, couple the second upper portion 2011a and the second lower portion 2012a together, and fix the end of the bracket half hinge 20a by engaging the engaging feet 204 into the second through holes 603; furthermore, connect the dragging end 402 of the dragging member 40 to the pull rod 70 by inserting the pull rod 70 into the first through holes 403.

When the electrical device 300 is used, a force can be applied on the pull rod 70 to drive the dragging member 40 to move along the second cavity 203a of the bracket half hinge 20a, while the fixed end 401 of the drag spring 40 drives the pivot shaft portion 102a of the axle half hinge 10a to rotate relative to the supporting arm 20a. Then the elastic member 30 deforms under the force and generates an elastic force therein. When the force disappears, the rotating arm returns to the original position under the elastic force of the elastic member 30.

Thus the hinge of the electrical device 300 of the present invention does not fray or break the cables, and the electrical device 300 has a longer usage life.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge comprising:
an axle half hinge, comprising:
a first arm portion defining a first cavity therein for receiving at least one electrical cable, and
a pivot shaft portion formed on an end of the first arm portion and defining a pivot hole communicating with the first cavity of the first arm portion; and
a bracket half hinge, comprising:
a second arm portion defining a second cavity therein for receiving the cable(s), and
a bracket portion formed on an end of the second arm portion and defining a receiving space for receiving the pivot shaft portion of the axle half hinge therein.

2. The hinge as claimed in claim 1, wherein the first arm portion comprising a first upper portion and a first lower portion coupled together.

3. The hinge as claimed in claim 2, wherein the first upper portion and the first lower portion each has a u-shaped section, the first cavity formed between the first upper portion and the first lower portion.

4. The hinge as claimed in claim 2, wherein the pivot shaft portion comprising an upper half shaft and a lower half shaft, the upper half shaft formed on an end of the first upper portion and the lower half shaft formed on an end of the first lower portion corresponding to the upper half shaft.

5. The hinge as claimed in claim 4, wherein the upper half shaft and the lower half shaft are arc-shaped for forming the pivot hole.

6. The hinge as claimed in claim 4, wherein the pivot shaft portion comprising a flange connected to the first arm portion, the flange partly formed on the outer surface of the upper half shaft and partly formed on the outer surface the lower half shaft.

7. The hinge as claimed in claim 4, wherein the upper half shaft and the lower half shaft each defining a gap near the first arm portion for communicating the pivot shaft portion and the first cavity.

8. The hinge as claimed in claim 1, wherein the second arm portion comprising a second upper portion and a second lower portion coupling with the second upper portion.

9. The hinge as claimed in claim 8, wherein the first upper portion and the first lower portion each has a u-shaped section, the second cavity formed between the second upper portion and the second lower portion.

10. The hinge as claimed in claim 8, wherein the bracket portion comprising an upper bracket and a lower bracket, the upper bracket formed on an end of the second upper portion and the lower bracket formed on an end of the second lower portion corresponding to the upper portion, the receiving space being defined between the upper bracket and the lower bracket.

11. The hinge as claimed in claim 10, wherein the bracket portion further defining a space, the space is partly defined on the upper bracket and partly defined on the lower bracket.

12. The hinge as claimed in claim 10, the bracket portion further includes two side covers formed on two opposite sides of the lower bracket for covering the two sides of the bracket portion.

13. An electrical device comprising:
a hinge comprising:
an axle half hinge, comprising:
a first arm portion defining a first cavity therein for receiving at least one electrical cable, and
an pivot shaft portion formed on an end of the first arm portion and defining a pivot hole communicating with the first cavity of the first arm portion;
a bracket half hinge, comprising:
a second arm portion defining a second cavity therein for receiving the cable(s), and
a bracket portion formed on an end of the second arm portion and defining a receiving space for receiving the pivot shaft portion of the axle half hinge therein;
an elastic member mounted between the joint of the axle half hinge and the bracket half hinge;
a dragging member passing through the second cavity of the bracket half hinge;
a combining cap formed on the end of the axle half hinge; and,
a pedestal connected to the end of the bracket half hinge 12.

14. The hinge as claimed in claim 13, wherein the elastic member includes a helix portion and two elastic feet expending from the helix portion, the helix portion being fixed around the pivot shaft portion of the axle half hinge, the two elastic feet are correspondingly resisted by the axle half hinge and the bracket half hinge.

15. The hinge as claimed in claim 13, wherein the dragging member includes a fixed end and a dragging end opposite to the fixed end, the fixed end is fixed on a side of the pivot shaft portion near the arm portion of the axle half hinge.

16. The hinge as claimed in claim 15, wherein the dragging end defines two first through holes, a pull rod being passed through the first through holes.

17. The hinge as claimed in claim 13, wherein the combining cap includes a first half cap formed on the end of the first upper portion and a second half cap formed on the end of the first lower portion, the first half cap and the second half cap forming a third cavity therebetween by being coupled together.

18. The hinge as claimed in claim 17, wherein the second half cap defining an opening for unfolding an output/input interface of the electrical element.

19. The hinge as claimed in claim 13, wherein the pedestal includes an annular seat and two opposing supporting plates integrated with the annular seat.

20. The hinge as claimed in claim 19, wherein the supporting plates respectively defines a second through hole, two engaging feet are formed on the two opposing side of the end of the bracket half hinge, the engaging feet are engaged in the corresponding second through holes.
